(19) United States
(12) Patent Application Publication
(10) Pub. No.: US 2008/0120262 A1
(43) Pub. Date: May 22, 2008

(54) WHAT-IF PLANNING FOR MEDICAL PROCEDURES

(75) Inventors: Raymond J.E. Habets, Eindhoven (NL); Rutger Nijlunsing, Veldhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/560,398

(22) Filed: Nov. 16, 2006

(51) Int. Cl. G06N 5/04

(52) U.S. Cl. 706/46

(57) ABSTRACT

Methods and apparatus are provided for improving the planning process for an activity such as a medical procedure. A what-if report is provided that includes predicted eventualities resulting from an initial change in a value of a parameter, as well as proposed alternative values of parameters, in which proposed values are adapted for the initial change in the value of the parameter.

The technical field of this invention is processes for planning a medical procedure, applications of which include clinical procedures such as orthopedic surgery.

Surgery remains a challenging endeavour despite recent advances in medical imaging technology. To minimize incidence of infection and a need for subsequent operations, surgery must be quick and accurate. One area of medicine in which this need is particularly acute is orthopedic surgery. A variety of tools are used to assist orthopedic surgeons in pre-operative planning tasks, such as selecting a hip implant of an appropriate size.

With a growing number of systems for picture archiving and communication (PACS), a number of orthopedic packages for PACS has also grown. A primary motivation for a growth in number of orthopedic packages is the need for a digital replacement for the planning of implants. Most commercial digital templating systems have modules for hip, knee and shoulder implants. Commercially available tools range from digital versions of old style transparent templates for overlaying on X-ray images to clinically accepted planning methods for assisted placement.

Currently available tools vary in complexity in performing a function to assist a surgeon in selection of a template having a correct size. Simpler tools offer only a list of templates from which the surgeon can choose. More elaborate tools offer measurements and wizards, viz a computerized set of stepwise instructions, to assist the user in the selection of a best fitting template. However, a process of selecting the best fitting template is not straightforward. For example, for hip replacement surgery, the surgeon takes into account each of a type of implant, a condition of the bone, a resulting offset, a resulting leg length difference, patient activity level, an obtained range of motion, a mode of fixation, bone deformity or deficiency, bearing surfaces, and patient economic concerns. An optimal template is a trade-off among these parameters. This trade-off generally falls beyond the capabilities of a digital templating system, as it involves the knowledge of the medical expert. Therefore, many template systems offer an elaborate selection scheme for templates, often based on the measurements that are integrated in these tools. Some tools offer a flat or hierarchical list of templates; others offer a set of lists of all individual parameters. Still other tools use filters in combination with linked lists of the parameters and locks to limit unwanted jumping during the selection process. In general, these implementations involve a complex selection procedure with many degrees of freedom, mapped to a set of complex user interface tools that control a very large database to come up with a correct template size.

The process described above is inflexible because an orthopedic surgeon selects the best fitting template and only the best fitting template is retained. The entire trade-off process with alternative options is not stored in a surgical report. Therefore, if a condition in the operating room causes the surgeon to use a different implant than the planned one, then the prior planning efforts are not useful.

Accordingly, an embodiment of the invention provided herein is a what-if report including a plurality of best fitting proposed values for a plurality of parameters in a problem in real time, for example a medical procedure, for example a surgical procedure, and including predicted eventualities arising from a change in a value of at least a first parameter, in which the change in the value is determined by a user in real time, the report further including a proposed alternative value of at least a second parameter, in which the alternative value of the at least second parameter is adapted for the change in the value of the first parameter.

Determining in real time the change in the value of the first parameter includes direct or indirect measurements, including measurements made by devices such as X-ray devices, magnetic resonance imaging devices, and computed tomography devices. Real time measurement includes measurement prior to or during a procedure, as well as post-procedure periods.

In a related embodiment, the report is presented in a tabular format having columns and/or rows. In another related embodiment, the plurality of proposed values is presented in rows. In yet another related embodiment, the plurality of proposed values is presented in columns. In a related embodiment, the plurality of proposed values is arranged according to values of a parameter.

In an alternative related embodiment, the report is presented in a textual format. In another related embodiment of the report, the plurality of best fitting proposed values includes at least one of the following parameters: length, distance, area, volume, density, concentration, angle, position, orientation, accuracy, fit, temperature, time, date, current, resistance, amount, luminous intensity, energy, force, power, velocity, and acceleration, or a measurement calculated from the at least one parameter.

In yet another related embodiment, the user of the report is a medical practitioner. In a related embodiment, the report is produced by a process for planning for surgery. In another related embodiment, the process is for a surgery selected from the group consisting of: abdominal surgery, dental surgery, oral and maxillofacial surgery, general surgery, laparoscopic surgery, plastic surgery, gynecological surgery, remote surgery, urology, vascular surgery, microvascular surgery, neurosurgery, otorhinolaryngolic surgery, cardiothoracic surgery, and ophthalmic surgery. In yet another related embodiment, the report is produced by a process for planning for orthopedic surgery.

In a related embodiment, the report includes at least one parameter selected from the group consisting of: cup diameter, stem size, ball size, offset, cup position, stem position, anteversion angle, inclination angle, and leg length difference.

Another embodiment of the invention herein is a medical planning system, in which the system produces a what-if report including a plurality of best fitting proposed values for a plurality of parameters in a problem in real time, for example a medical procedure, for example a surgical procedure, and including predicted eventualities arising from a change in a value of at least a first parameter, in which the change in the value is determined by a user in real time, the report further including a proposed alternative value of at least a second parameter, in which the alternative value of the at least second parameter is adapted for the change in the value of the first parameter, and a user of the report is a medical practitioner.

Another embodiment of the invention herein is a picture archiving and communication system, in which the system produces a what-if report including a plurality of best fitting proposed values for a plurality of parameters in a problem in real time, for example a medical procedure, for example a surgical procedure, and including predicted eventualities arising from a change in a value of at least a first parameter, in which the change in the value is determined by a user in real time, the report further including a proposed alternative value of at least a second parameter, in which the alternative value of the at least second parameter is adapted for the change in the value of the first parameter, and a user of the report is a medical practitioner.

Another embodiment of the invention herein is a method of producing a what-if report, including: producing a plurality of best fitting proposed values for a plurality of parameters in a problem in real time, for example a medical procedure, for example a surgical procedure; and producing predicted eventualities arising from a change in a value of at least a first parameter, in which the change in the value is determined by a user in real time, the report further including a proposed alternative value of at least a second parameter, in which the alternative value of the at least second parameter is adapted for the change in the value of the first parameter.

In a related embodiment, the method further includes producing a plurality of best fitting proposed values that includes at least one of the following parameters: length, distance, area, volume, density, concentration, angle, position, orientation, accuracy, fit, temperature, time, date, current, resistance, amount, luminous intensity, energy, force, power, velocity, and acceleration, or a measurement calculated from the at least one parameter.

Another embodiment of the invention herein is a process for planning for surgery, in which the process includes a method of producing a what-if report, including a plurality of best fitting proposed values for a plurality of parameters in a problem in real time, for example a medical procedure, for example a surgical procedure, and including predicted eventualities arising from a change in a value of at least a first parameter, in which the change in the value is determined by a user in real time, the report further including a proposed alternative value of at least a second parameter, in which the alternative value of the at least second parameter is adapted for the change in the value of the first parameter.

In a related embodiment, the process for planning for surgery is for a surgery selected from the group consisting of: abdominal surgery, dental surgery, oral and maxillofacial surgery, general surgery, laparoscopic surgery, plastic surgery, gynecological surgery, remote surgery, urology, vascular surgery, microvascular surgery, neurosurgery, otorhinolaryngolic surgery, cardiothoracic surgery, and ophthalmic surgery. In another related embodiment, the process is a process for planning for orthopedic surgery.

In another related embodiment, the process includes at least one of the following parameters: cup diameter, stem size, ball size, offset, cup position, stem position, anteversion angle, inclination angle, and leg length difference.

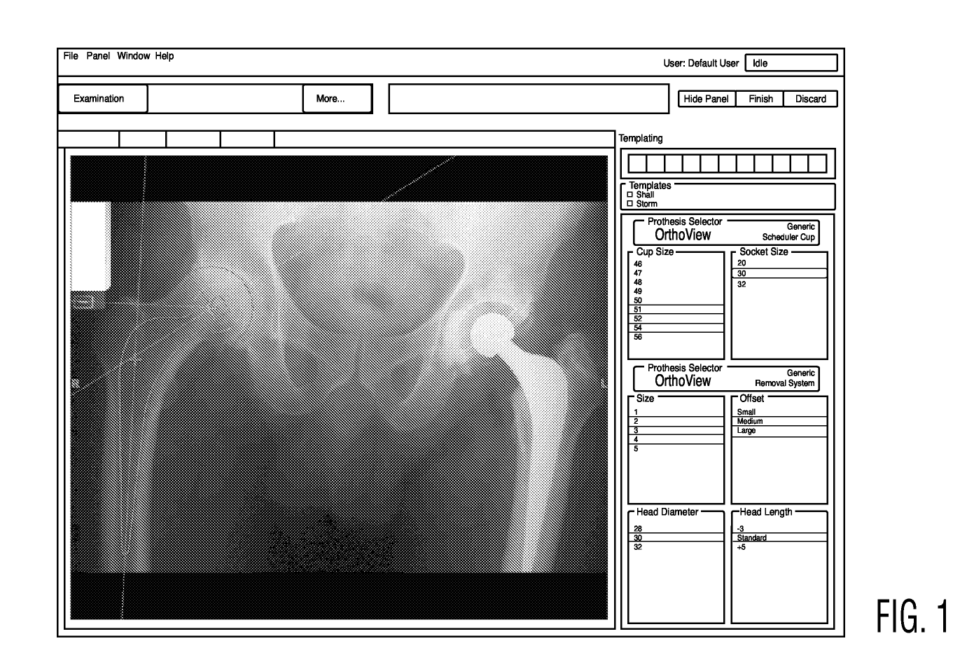

FIG. 1 is an image of the Orthoview hip implant planning tool. The panel on the right side shows the cup and stem selection panels. The suggested best fitting sizes are shaded.

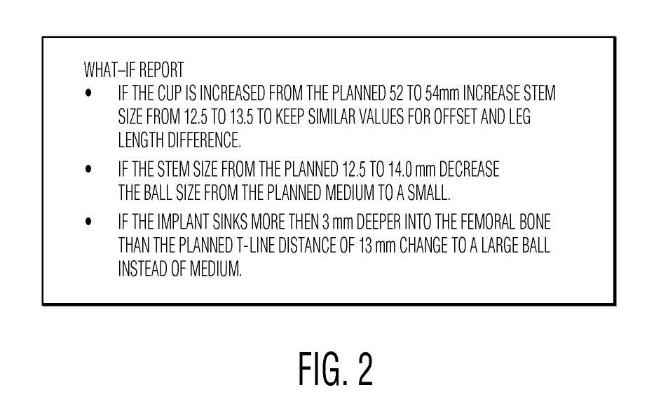

FIG. 2 is an example of a textual format of a what-if report containing three “what-if” scenarios. The first scenario relates to a deviation from the planned cup size. The second scenario relates to a deviation from the planned stem size. The third example relates to a situation in which the stem sinks deeper into the femoral shaft than expected.

Accordingly, the invention described herein can be used in any application where a process is used to select items based on a list of settings that the user has to provide, i.e. selection processes typified by an absence of fixed rules and/or the presence of many exceptions. The method and apparatus described herein are directed to an orthopedic planning process, however, other planning processes, for example other medical planning processes, are within the scope of this invention.

Embodiments of the invention described herein are applicable to planning for activities in which a process is used to select items based on a list of parameters provided by a user.

An embodiment of the invention provided herein is a “what-if” report. This report may be utilized by one or more medical practitioners at a time. The what-if report is used either as one part of another larger report, or per se as a separate document.

An embodiment of the invention provides a plurality of best fitting proposed values for a plurality of parameters in a medical procedure. The report provides predicted eventualities resulting from a change in a value of a first parameter, for example, a change that occurs during a medical procedure as a result of conditions present during the medical procedure. The report further provides several proposed alternative values of at least one parameter, in which the proposed values are adapted for the change in the value of the first parameter.

Changes in values of parameters reflect conditions that are encountered during a medical procedure. For example, a condition of bone may be different from what had been expected. The what-if report provides, for example, at least two sets of information: first, the results that would be obtained by the change without altering the rest of the plan; and, second, at least one proposed alternative value of at least one other parameter, such that eventualities are optimized. In some embodiments, the report also provides results that would be obtained by using one or more alternative values of the parameters.

In this manner, the report covers a range of possible clinical deviations from the normal execution of the plan. For example, the what-if report is used even if the best fitting implant cannot be used.

Further, in some embodiments, the planning system is used prior to a procedure, for example, outside of an operating room. In other embodiments, the planning system is available during the procedure.

Exemplary situations in which a “What-if” report can assist the surgeon include and are not limited to:
what if the cup implant size is increased or decreased:
what if the cup position is changed:
what if the stem size or position (if it settles deeper than expected) is changed:
what if a different ball size is selected:
what if the bone condition forces the use of a different family of implant.

An embodiment of the invention described herein is a textual report. An example of this embodiment is shown in FIG. 2. A further embodiment of a textual report uses conditional sentences, such as an “if-then” structure. The “if” condition describes a deviation from the best fitting proposed value. The “then” component suggests modification that the surgeon might make. Clarity is promoted by including only the most likely deviations from the best fitting proposed values.

Another embodiment uses tables to communicate the what-if report. An example of this embodiment is shown in Table 1. For each possible initial change in a parameter arising from intraoperative conditions, a table is presented showing proposed alternative values of other parameters in response to the initial change in parameter.

TABLE 1
“What-if” table for selecting a different cup than the planned 54 mm cup for a hip
replacement surgery. The left side of the table shows what the effects of changing the cup
would be if the rest of the planning is left intact. The right side of the table proposes the optimal
changes to make to the other parameters in order to come closer to the optimal result.

| | | | | | What-if | | | |
|---|---|---|---|---|---|---|---|---|
| | Planned | | | | Suggestion | | | |
| What-if Cup | Stem | Results | | | Stem | Results | | |
| cup diameter (mm) | Size | Ball | Offset (mm) | LLdiff (mm) | Size | Ball | Offset (mm) | LLdiff (mm) |
| 50 | | | | −4 | CLS 13.5 | M | 48 | −1 |
| 54 | CLS 14.5 | M | 50 | 0 | | | | |
| 58 | | | | 4 | CLS 14.5 | S | 49 | 1 |

“LLdiff” represents leg length difference.

It will furthermore be apparent that other and further forms of the invention, and embodiments other than the specific and exemplary embodiments described above, may be devised without departing from the spirit and scope of the appended claims and their equivalents, and therefore it is intended that the scope of this invention encompasses these equivalents and that the description and claims are intended to be exemplary and should not be construed as further limiting.

What is claimed is:

1. A what-if report, comprising a plurality of best fitting proposed values for a plurality of parameters in a medical procedure and comprising predicted eventualities arising from a change in a value of at least a first parameter, wherein the change in the value is determined by a user in real time, the report further comprising a proposed alternative value of at least a second parameter, wherein the alternative value of the at least second parameter is adapted for the change in the value of the first parameter.

2. The report according to claim 1, wherein the report is presented in a tabular format having columns and/or rows.

3. The report according to claim 2, wherein the plurality of proposed values is presented in rows.

4. The report according to claim 2, wherein the plurality of proposed values is presented in columns.

5. The report according to claim 3, wherein the plurality of proposed values is arranged according to values of a parameter.

6. The report according to claim 1, wherein the report is presented in a textual format.

7. The report according claim 1, wherein the plurality of proposed values further comprises at least one parameter selected from the group consisting of: length, distance, area, volume, density, concentration, angle, position, orientation, accuracy, fit, temperature, time, date, current, resistance, amount, luminous intensity, energy, force, power, velocity, and acceleration, or a measurement calculated from the at least one parameter.

8. The report according to claim 1, wherein the user is a medical practitioner.

9. The report according to claim 8, wherein the report is produced by a process for planning for surgery.

10. The report according to claim 9, wherein the process is for planning for a surgery selected from the group consisting of: abdominal surgery, dental surgery, oral and maxillofacial surgery, general surgery, laparoscopic surgery, plastic surgery, gynecologic surgery, remote surgery, urology, vascular surgery, microvascular surgery, neurosurgery, otorhinolaryngolic surgery, cardiothoracic surgery, and ophthalmic surgery.

11. The report according to claim 9, wherein the report is produced by a process for planning for orthopedic surgery.

12. The report according to claim 11, further comprising at least one parameter selected from the group consisting of: cup diameter, stem size, ball size, offset, cup position, stem position, anteversion angle, inclination angle, and leg length difference.

13. A medical planning system, wherein the system produces the report according to claim 1.

14. A picture archiving and communication system, wherein the system produces the report according to claim 1.

15. A method of producing a what-if report, the method comprising:
producing a plurality of best fitting proposed values for a plurality of parameters in a medical procedure; and
producing predicted eventualities arising from a change in a value of at least a first parameter, wherein the change in the value is determined by a user in real time, the report further comprising a proposed alternative value of at least a second parameter, wherein the alternative value of the at least second parameter is adapted for the change in the value of the first parameter, thereby producing a what-if report.

16. The method according claim 15, wherein the method further comprises producing a plurality of best fitting proposed values that further comprises at least one parameter selected from the group consisting of: length, distance, area, volume, density, concentration, angle, position, orientation, accuracy, fit, temperature, time, date, current, resistance, amount, luminous intensity, energy, force, power, velocity, and acceleration, or a measurement calculated from the at least one parameter.

17. A process for planning for surgery, wherein the process includes the method of claim 15.

18. The process according to claim 17, wherein the process for planning for surgery is for a surgery selected from the group consisting of: abdominal surgery, dental surgery, oral and maxillofacial surgery, general surgery, laparoscopic surgery, plastic surgery, gynecologic surgery, remote surgery, urology, vascular surgery, microvascular surgery, neurosurgery, otorhinolaryngolic surgery, cardiothoracic surgery, and ophthalmic surgery.

19. The process according to claim 17, wherein the process is a process for planning for orthopedic surgery.

20. The process according to claim 19, further comprising at least one parameter selected from the group consisting of: cup diameter, stem size, ball size, offset, cup position, stem position, anteversion angle, inclination angle, and leg length difference.
